(19) United States
(12) Patent Application Publication
(10) Pub. No.: US 2012/0241231 A1
(43) Pub. Date: Sep. 27, 2012

(54) Hydraulic power system for light vehicles

(76) Inventors: Daniel Joseph Sullivan, Morrow, GA (US); Nicholas Anthony Sullivan, Morrow, GA (US)

(21) Appl. No.: 12/925,630

(22) Filed: Mar. 21, 2011

(51) Int. Cl. B60L 11/00; H02K 53/00

(52) U.S. Cl. 180/65.1; 74/DIG. 9

(57) ABSTRACT

The purpose of the Self-Generating Hydraulic Power System is to create a power system for use in automobiles other than the gasoline powered engines currently used. This is accomplished by combining two parts, the power system and the hydraulic motor, the combination of which will allow a vehicle to move without the use of petroleum (gasoline) or petroleum based products (natural oil).

In part A, an alternator is run by a motor, which is powered by a battery. What is intended is that while the motor running the alternator, and the hydraulic motor (part B) which makes the vehicle move, are taking power out of the battery, the alternator is recharging the battery, creating a complete power system to move a vehicle without the need for gasoline, and that does not need to be plugged in to be recharged.

These diagrams lay out the design for a hydraulic power system to run vehicles in place of the currently used combustion engines, or the electric motors that must be plugged in to be recharged. This power system will run using a 100% synthetic oil, so no petroleum or petroleum based products need to be used, eliminating our dependence on foreign oil, and providing an alternative to the fossil fuels we currently use.

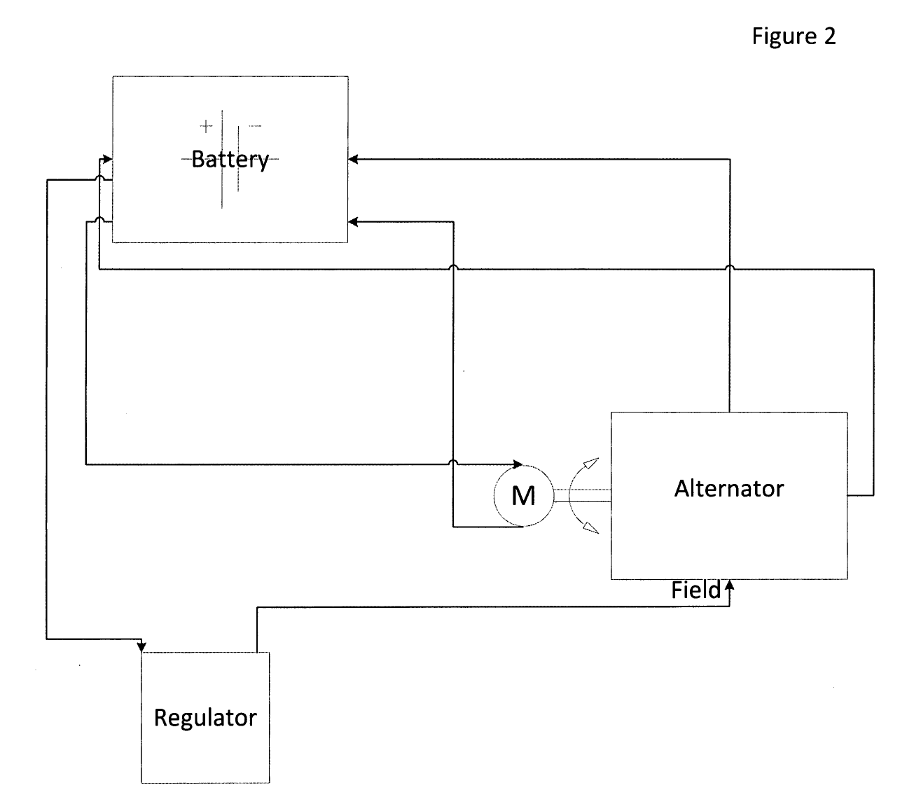

In FIG. 2, the design for the electrical system is displayed. The battery connects to the motor, giving the motor power. The motor then connects to the alternator, turning the alternator to create a charge. The regulator determines whether the battery is at full charge or not. If the battery is not fully charged, the charge created by the alternator then travels back into the battery, recharging the battery. If the battery is at full power, the alternator idles until the battery has expended some of its charge, then starts creating a charge again. This part of the power system runs constantly, keeping the battery at a full charge.

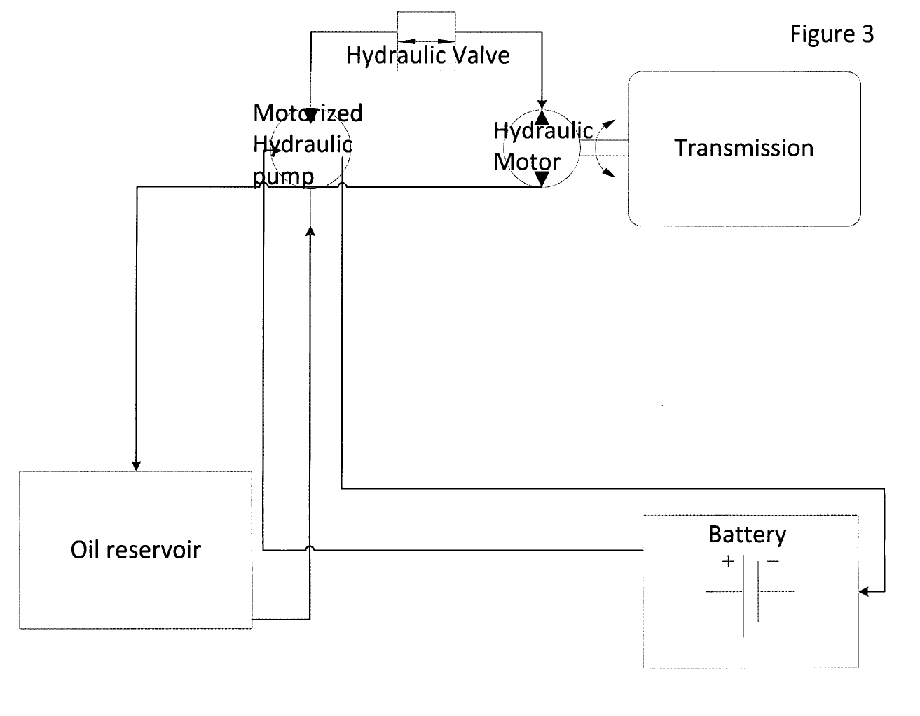

In FIG. 3, the hydraulic system is displayed. The reservoir holds 100% synthetic oil. That synthetic oil travels from the reservoir to the pump. The pump, powered by an electronic motor, which receives its power from the electrical system presented in FIG. 2, pushes the synthetic oil into a valve. If the valve is open (the operator of the vehicle is accelerating or maintaining speed) the synthetic oil travels to the hydraulic motor through a tube that is 1 inch on the valve side and ¼ inch on the hydraulic motor side. If the valve is closed (the operator of the vehicle is slowing down, stopping, or stopped) the synthetic oil travels back to the reservoir. If the valve is open (the operator of the vehicle is accelerating or maintaining speed) the synthetic oil powers the hydraulic motor, which turns the vehicles transmission, either maintaining or accelerating the vehicles speed, depending on what the operator of the vehicle is doing.

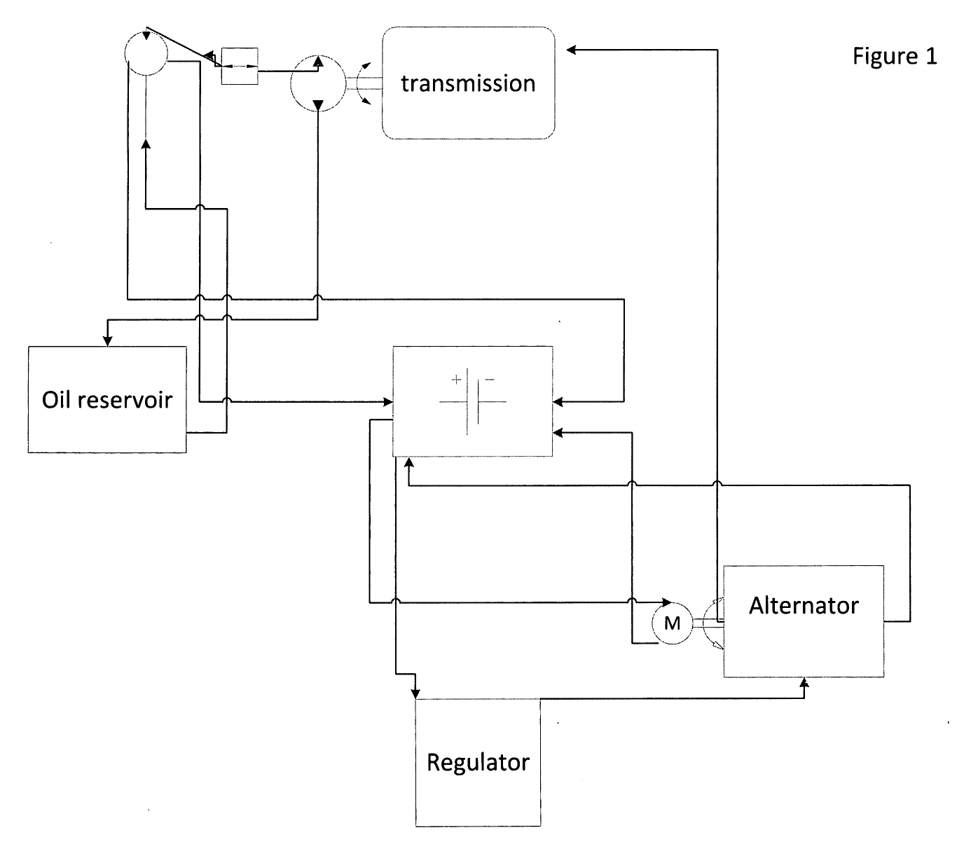

Through the combination of FIG. 1 and FIG. 2, represented by FIG. 1, we are able to create a new power system for a vehicle that runs without the need for petroleum or petroleum based products, and without the need to plug it in to recharge. This will allow us to reduce our dependency on foreign oil, and eliminate our need to use fossil fuels in the operation of a vehicle.

### BRIEF DESCRIPTION

FIG. 1 The Entire Power System

This diagram shows the hydraulic power system in its entirety. This is the combination of both the electrical system (FIG. 2) and the hydraulic system (FIG. 3). The electrical system (FIG. 2) creates the power to run the hydraulic system (FIG. 3) which turns a vehicles transmission, either maintaining or accelerating the vehicle. This is accomplished using only 100% synthetic oil. The need for fossil fuels as seen in current combustible engines is eliminated, and the electrical system creates keeps the battery constantly charged, eliminating the need to plug the vehicle in to recharge.

FIG. 2 Electrical Sysytem

In FIG. 2, the design for the electrical system is displayed. The battery connects to the motor, giving the motor power. The motor then connects to the alternator, turning the alternator to create a charge. The regulator determines whether the battery is at full charge or not. If the battery is not fully charged, the charge created by the alternator then travels back into the battery, recharging the battery. If the battery is at full power, the alternator idles until the battery has expended some of its charge, then starts creating a charge again. This part of the power system runs constantly, keeping the battery at a full charge.

FIG. 3 Hydraulic System

In FIG. 3, the hydraulic system is displayed. The reservoir holds 100% synthetic oil. That synthetic oil travels from the reservoir to the pump. The pump, powered by an electronic motor, which receives its power from the electrical system presented in FIG. 1, pushes the synthetic oil into a valve. If the valve is open (the operator of the vehicle is accelerating or maintaining speed) the synthetic oil travels to the hydraulic motor through a tube that is 1 inch on the valve side and ¼ inch on the hydraulic motor side. If the valve is closed (the operator of the vehicle is slowing down, stopping, or stopped) the synthetic oil travels back to the reservoir. If the valve is open (the operator of the vehicle is accelerating or maintaining speed) the synthetic oil powers the hydraulic motor, which turns the vehicles transmission, either maintaining or accelerating the vehicles speed, depending on what the operator of the vehicle is doing.

1. We claim that by using a combination of a self-generating electrical system and hydraulic system we can run a vehicle without the need for petroleum or petroleum based products, and without the need to plug it in to charge the battery.
The self-generating power system is created by; running a motor off of a battery, which turns an alternator, which then charges the battery running the motor, creating the self-generating power system.
The hydraulic system is created by; running a hydraulic motor off of a hydraulic pump using 100% synthetic oil, which turns a transmission, which then moves a vehicle.

2. We claim that by using the self-generating power system described in claim 1, we can provide electricity to buildings and/or recreational vehicles.
